(19) United States
(12) Patent Application Publication
(10) Pub. No.: US 2011/0246966 A1
(43) Pub. Date: Oct. 6, 2011

(54) EMBEDDING SOURCE FILES INTO PROGRAM SYMBOL FILES

(75) Inventor: Vincent Edward Harron, III, Solana Beach, CA (US)

(73) Assignee: SONY COMPUTER ENTERTAINMENT AMERICA INC., Foster City, CA (US)

(21) Appl. No.: 12/755,331

(22) Filed: Apr. 6, 2010

(51) Int. Cl. G06F 9/44

(52) U.S. Cl. 717/124

(57) ABSTRACT

Appending source files for debugging a program, including: receiving object data and a plurality of matching symbol data corresponding to the source files; first appending the received object data to object files and the plurality of matching symbol data to a set of symbol files; second appending the source files to the set of symbol files; and merging the object files and the set of symbol files.

### BACKGROUND

1. Field of the Invention

The present invention relates to debugging programs, and more specifically, to embedding source files into program symbol files for more efficient debugging.

2. Background

A programmer develops a software program by producing and entering source code into files using a text editor program. The computer then creates an executable file by translating or compiling the source code into machine code, which is sometimes referred to as object code. The object code is a sequence of instructions that the processor can understand and execute but that is difficult for a human to read or modify. The software development process described above is accomplished by running a series of programs. These programs typically include a compiler for translating the source code into object code and a linker to link the object codes together to form a machine code program.

When developing computer software, it is necessary to perform a function termed “debugging,” which involves testing and evaluating the software to find and correct any errors and improper logic operation. An effective debugger program is necessary for rapid and efficient development of software.

A conventional debugging system includes a combination of computer hardware and debugger software that executes a user's program in a controlled manner. Debugging aids a user in identifying and correcting mistakes in an authored program by allowing the program to be executed in small segments. To this end, debugging provides functions including breakpoints, run-to-cursor, step into, step over and the like. Debugging is often necessary not only during initial development, but post-development when the code is being used by end-users. This may occur, for example, because the code was not fully tested by the developer or because end-users initialize the code in a manner not contemplated by the developer. Typically, compilers encode debugging information in the object code, which debuggers use to map source lines with the generated machine instructions that get executed, and source variables with memory and data locations that hold the values of these variables, along with other information.

On many operating systems, a core file is created for debugging purposes when a program terminates unexpectedly. The operating system terminates the program and creates a core file that programmers and developers can use to determine what went wrong. The core file contains a detailed description of the state that the program was in when it terminated, which can serve as useful debugging aids in several situations. However, when a programmer/developer receives a core file, it is very difficult to get any value out of it without a set of symbol files that precisely matches the modules that were loaded when the core file was created.

### SUMMARY

The present invention provides for appending source files for debugging a program.

In one implementation, a method of appending source files for debugging a program is disclosed. The method including: receiving object data and a plurality of matching symbol data corresponding to the source files; first appending the received object data to object files and the plurality of matching symbol data to a set of symbol files; second appending the source files to the set of symbol files; and merging the object files and the set of symbol files.

In another implementation, a computer-readable storage medium storing a computer program for appending source files for debugging the computer program is disclosed. The computer program includes executable instructions that cause a computer to: receive object data and a plurality of matching symbol data corresponding to the source files; first append the received object data to object files and the plurality of matching symbol data to a set of symbol files; second append the source files to the set of symbol files; and merge the object files and the set of symbol files.

In a further implementation, a system for appending source files for debugging a program is disclosed. The system including: means for receiving object data and a plurality of matching symbol data corresponding to the source files; first means for appending the received object data to object files and the plurality of matching symbol data to a set of symbol files; second means for appending the source files to the set of symbol files; and a linker to merge the object files and the set of symbol files.

Other features and advantages of the present invention will become more readily apparent to those of ordinary skill in the art after reviewing the following detailed description and accompanying drawings.

### BRIEF DESCRIPTION OF THE DRAWINGS

FIG. 1 shows a functional block diagram illustrating a system for appending an archive of original source files into a program symbol file in accordance with one implementation of the present invention.

FIGS. 2A, 2B, and 2C show a detailed functional block diagram illustrating the process for appending an archive of original source files into a program symbol file in accordance with one implementation of the present invention.

FIG. 3 is a flowchart illustrating a process for appending an archive of original source files into a program symbol file in accordance with one implementation of the present invention.

### DETAILED DESCRIPTION

Certain implementations as disclosed herein provide for appending a complete or partial archive of original source files into a program symbol file. The term “appending,” as used herein, can refer to both attaching and embedding/inserting. After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

As discussed above, a core file is created for debugging purposes when a program terminates unexpectedly. The operating system terminates the program and creates a core file that programmers and developers can use to determine what went wrong. The core file contains a detailed description of the state that the program was in when it terminated, which can serve as a useful debugging aid in several situations. When a programmer/developer receives the core file, it is very difficult to get any value out of it without a set of symbol files that precisely matches the modules that were loaded when the core file was created. However, finding a set of matching symbol files is not a trivial task because a core file from a specific date could correspond to a version built on a developer's system, a version in test, a version in format quality assurance (QA) or a retail version of a game.

A symbol file contains a mapping from program offsets to function name, source file name, and line number. Thus, with a core file and a matching set of symbol files, a developer can find the source of the problem very quickly. Even more information can be obtained if the developer can somehow retrieve a set of source files that precisely matches the set of symbol files. However, the original source files are not currently included in a program symbol file. Further, there is no automatic way of getting a set of matching source files. If a developer wants to view the original source files during debugging, a set of source files that matches the program symbol file must be manually retrieved. However, finding a complete set of matching source files for a core file is even more difficult than finding the symbol files. Custom schemes for retrieving matching source files from source control systems are complicated to set up. If the source files for a particular build do not exist in the source control, the scheme will not work at all.

In one implementation, original source files can be appended to the symbol files to provide an efficient scheme for finding a set of source files that matches the set of symbol files. In this implementation, the original source files are attached or embedded into every object file. Thus, the source files are present in library files, and ultimately in executable and linkable format (elf) files. Further, duplicate source files can be pruned for efficiency. Accordingly, attaching or embedding source files into the symbol files makes debugging easier and more automatic.

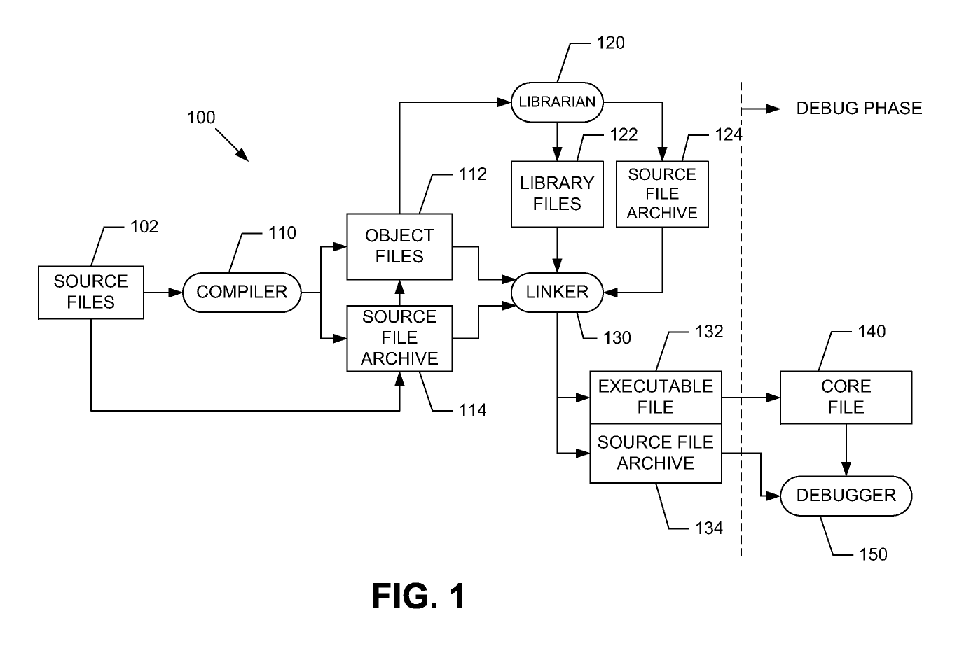

FIG. 1 shows a functional block diagram 100 illustrating a system for appending an archive of original source files into a program symbol file in accordance with one implementation of the present invention. In the illustrated implementation of FIG. 1, a program compiler 110 compiles the source files 102 to produce object data and a set of matching symbol data, which is appended or embedded into object files 112. In other implementations, the set of matching symbol data is inserted into a separate symbol database. The original source files can also be embedded into the symbol database along with the symbol data. The output file, which includes symbol data, is referred to as source file archive 114, and can be appended to the object files 112.

In the illustrated implementation of FIG. 1, a library archiving unit 120 merges object data from the object files 112 and symbol data from the source file archive 114 to produce library files 122 and output source file archive 124. In the merging process, the library archiving unit 120 discards the duplicates of the symbol data and/or the source files.

A program linker 130 merges the object files 112, the symbol files 114, the library files 122, and/or the output source file archive 124 to generate an executable file 132 including symbol data. The symbol data generated in this phase can be stored in the executable file or in a separate symbol file. The output file that includes the symbol data is referred to as output source file archive 134 of the linking phase. As with the library generation phase, the linker 130 discards the duplicates of the symbol data and/or the source files in the linking phase.

When a program terminates unexpectedly, a core file 140 is generated for debugging purposes. A debugger 150 receives the core file 140 and the source file archive 134 of the linking phase, which includes all non-duplicate symbol data and the archive of the non-duplicate source files.

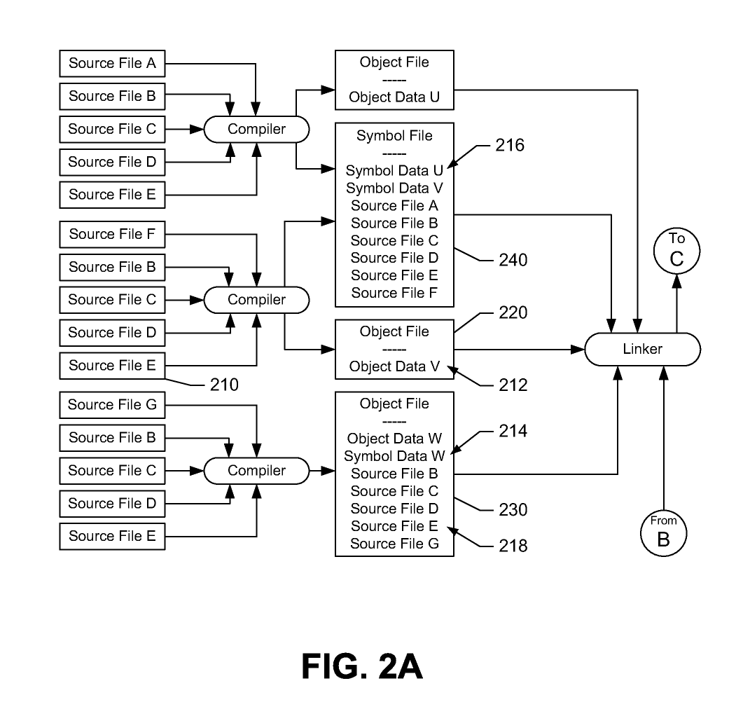

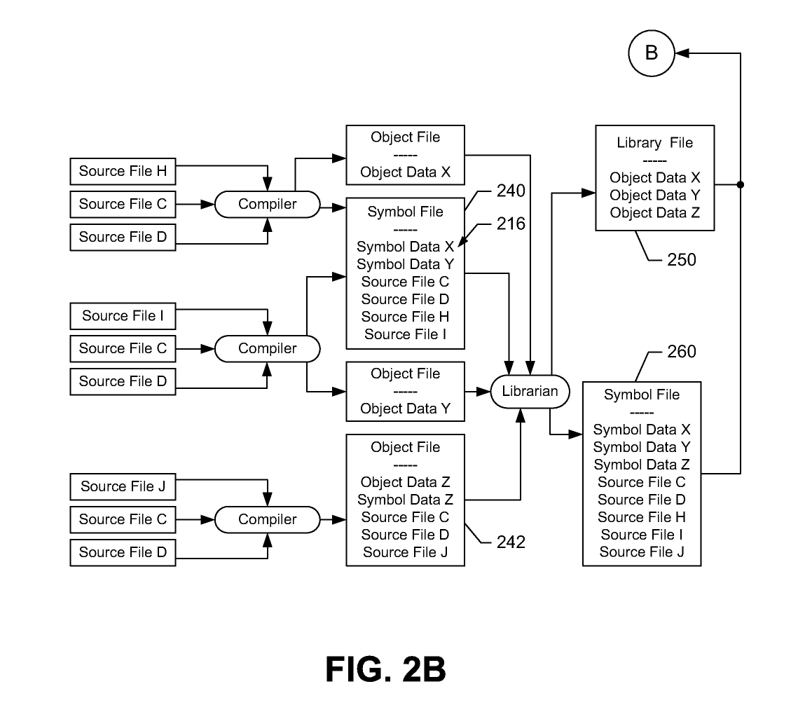

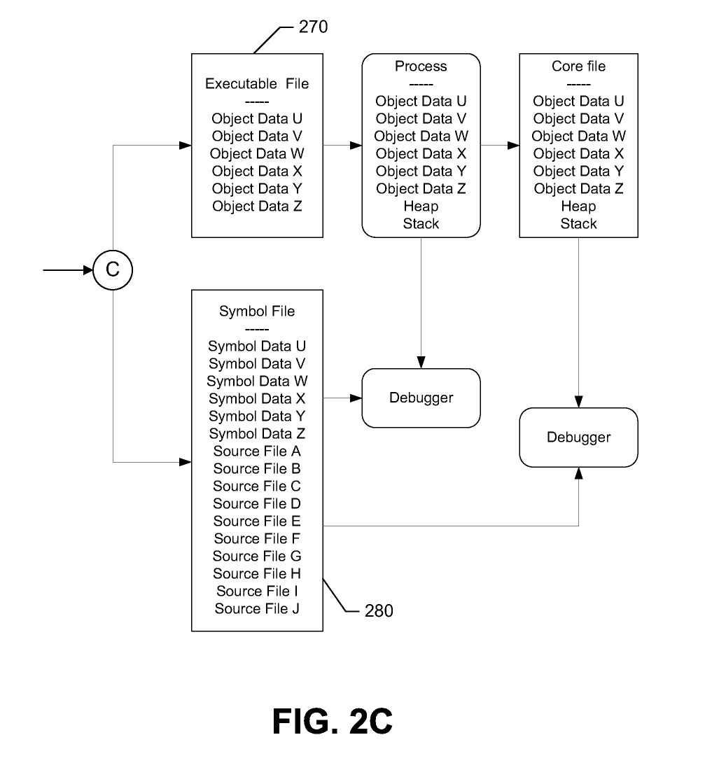

FIGS. 2A, 2B, and 2C show a detailed functional block diagram illustrating the process for appending an archive of original source files into a program symbol file in accordance with one implementation of the present invention. The illustrated implementation of FIGS. 2A, 2B, and 2C shows the process in four phases: (1) a compile phase; (2) a library generation phase; (3) a linking phase; and (4) a debugging phase.

During the compile phase (see FIG. 2A), source files (e.g., 210) are converted into object data (e.g., 212) and symbol data (e.g., 214). The object data 212 is written to an object file (e.g., 220). Symbol data (e.g., 214 or 216) is appended to the object file (e.g., 230 for symbol data 214) or inserted into a symbol database (e.g., 240 for symbol data 216). Original source files (e.g., 218) can also be embedded alongside symbol data (e.g., 214). The output file (e.g., 230) that includes symbol data (e.g., 214) is referred to as source file archive.

In one implementation, the source files are embedded as follows. Initially, a hash for each source file that is given as a compiler output is calculated. For this purpose, strong cryptographic hash functions such as MD5, SHA-1, and/or SHA-2 techniques are recommended. The source files (e.g., 218) in the source file archive (e.g., 230) are then indexed by both the unique hash and the original file system path. These indices are referred to as hash index and path index, respectively, and enable efficient retrieval and duplicate omission. If a source file already exists in the hash index, then the source file is already present in the archive and does not need to be inserted again. However, if the source file is not found in the hash index of the source file archive, then the source file is compressed using a compression technique such as LZMA or ZIP. The compressed source file bytes are inserted into the source file archive and the hash value is inserted into the hash index. If the file system path of the source file is not in the path index of the source file archive, then the file system path of the source file is inserted into the path index.

During the library generation phase (see FIG. 2B), object files (e.g., 242) and/or symbol files (e.g., 240) are combined to create a library file (e.g., 250). The symbol data generated in this phase can be stored in the library file or a separate symbol file (e.g., 260). The output file 260 that contains the symbol data is referred to as output source file archive (OSFA) of the library generation phase. The OSFA also includes hash and path indices that enable efficient lookup and duplicate omission. Some library phase input files may include compressed, indexed source files. These files (e.g., 242) are referred to as input source file archives (ISFA) of the library generation phase.

Each source file in each ISFA is considered for insertion into the OSFA. The hash values for each input source file do not need to be re-calculated, since the ISFA already includes hash values. The hash index of the OSFA is searched for in the hash of each source file in each ISFA. If a source file already exists in the hash index of the OSFA, then the source file is already present in the archive and does not need to be inserted again. However, if the source file is not found in the hash index of the OSFA, then the compressed source file bytes are copied from the ISFA to the OSFA, and the hash value is inserted into the hash index. If the file system path of the source file is not in the path index of the OSFA, the file system path is inserted into the path index.

During the linking phase (see FIGS. 2A through 2C), object files (e.g., 220), symbol files (e.g., 240) and/or library files (e.g., 250) are combined to create an executable file (e.g., 270). Symbol data generated in this phase can be stored in the executable file or a separate symbol file (e.g., 280). The output file (e.g., 280) that includes the symbol data is referred to as output source file archive (OSFA) of the linking phase, which also includes hash and path indices that enable efficient lookup and duplicate omission. Some linking phase input files (e.g., 260) may include compressed, indexed source files. These files are referred to as input source file archives (ISFA) of the linking phase.

Each source file in the each ISFA is considered for insertion into the OSFA of the linking phase. The hash values for each input source file do not need to be re-calculated since the ISFA already includes hash values. The hash index of the OSFA is searched for in the hash of each source file in each ISFA. If a source file already exists in the hash index of the OSFA, the source file is already present in the archive and does not need to be inserted again. However, if the source file is not found in the hash index of the OSFA, the compressed source file bytes are copied from the ISFA to the OSFA and the hash value is inserted into the hash index. If the file system path of the source file is not in the path index of the OSFA, the file system path is inserted into the path index.

During the debugging phase, program execution can be paused at any point. Symbol data can be used to map from an executable file location to the file system path and the line number of the original source file. The symbol data can be extended to include the hash value of the original source file. The path or hash value retrieved from the symbol data can be used to search the indices of the source file archive corresponding to the executable file. If a matching source file is found, the compressed source file bytes can be decompressed into a temporary location. The debugger can use the file to display original source information to the user. However, if the file is not found in the source file archive, the debugger can default back to searching the host file system of the debugger.

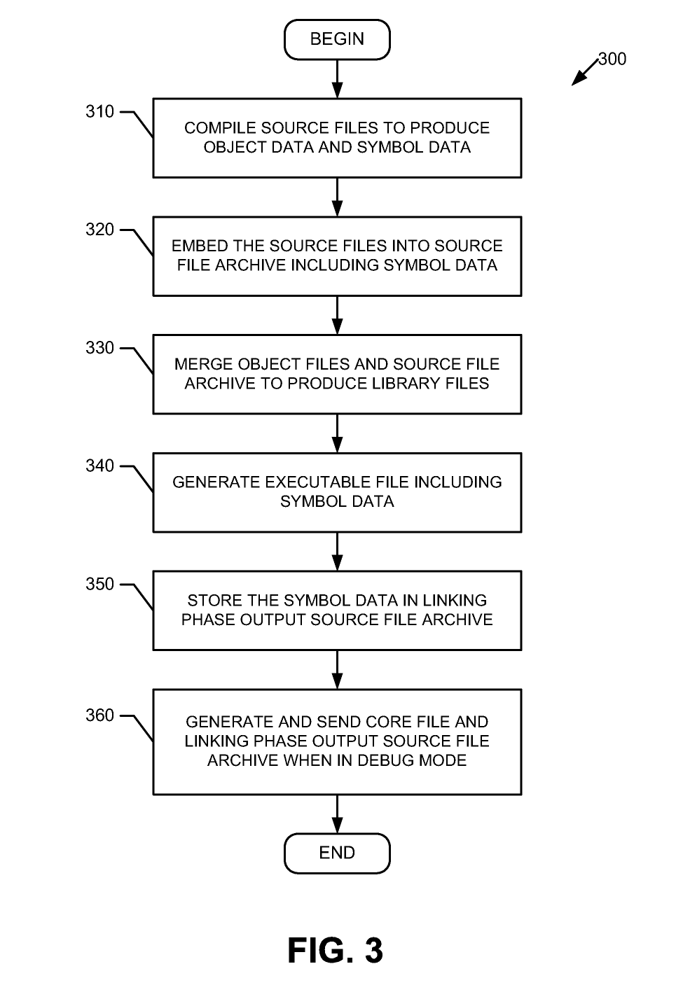

FIG. 3 is a flowchart 300 illustrating a process for appending an archive of original source files into a program symbol file in accordance with one implementation of the present invention. In the illustrated implementation of FIG. 3, source files are compiled, at box 310, to produce object data and a set of matching symbol data, which is appended or embedded into object files. In other implementations, the set of matching symbol data is inserted into a separate symbol database. At box 320, the original source files are embedded into the symbol database along with the symbol data. The output file, which includes symbol data, is referred to as source file archive, and can be appended to the object files.

In the illustrated implementation of FIG. 3, object data from the object files and symbol data from the source file archive are merged, at box 330, to produce library files and output source file archive. In the merging process, duplicates of the symbol data and/or the source files are discarded. An executable file including symbol data is generated, at box 340, by merging the object files, the symbol files, the library files, and/or the output source file archive using a linker. The symbol data generated in this phase is stored, at box 350, in an output file, which is referred to as output source file archive of the linking phase. The output file may be the executable file or a separate symbol file. Again, the duplicates of the symbol data and/or the source files are discarded. Thus, when a program terminates unexpectedly, a core file and the output source file archive of the linking phase are generated and sent, at box 360, for debugging purposes. As mentioned above, the output source file archive of the linking phase includes all non-duplicate symbol data and the archive of the non-duplicate source files.

The description herein of the disclosed implementations is provided to enable any person skilled in the art to make or use the invention. Numerous modifications to these implementations would be readily apparent to those skilled in the art, and the principals defined herein can be applied to other implementations without departing from the spirit or scope of the invention. For example, although the specification describes compilers and linkers embedding source files into output program symbol files, tool(s) separate from the compiler or linker can be written to embed the source files in the output program symbol file. That is, the source files can be written to a file separate from the program symbol file but be associated with the program symbol file in some way. For example, the program symbol file and the source files can have the same name but different extensions. Thus, the invention is not intended to be limited to the implementations shown herein but is to be accorded the widest scope consistent with the principal and novel features disclosed herein.

Various implementations of the invention are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a computer-readable storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. A method of appending source files for debugging a program, comprising:
receiving object data and a plurality of matching symbol data corresponding to the source files;
first appending the received object data to object files and the plurality of matching symbol data to a set of symbol files;
second appending the source files to the set of symbol files; and
merging the object files and the set of symbol files.

2. The method of claim 1, wherein merging comprises discarding duplicates of the plurality of matching symbol data and the source files.

3. The method of claim 1, further comprising
translating the source files to produce object data and a set of matching symbol data.

4. The method of claim 1, wherein the object files and the set of symbol files constitute same files, such that the first appending and the second appending comprise
inserting the received object data, the received plurality of matching symbol data, and the source files into the same files.

5. The method of claim 1, further comprising
generating an executable files by merging the object files, the set of symbol files, and library files.

6. The method of claim 1, further comprising:
generating an executable file by merging the object files and library files; and
appending the set of symbol files to the executable file.

7. The method of claim 6, further comprising
storing the executable file along with the set of symbol files which includes appended source files.

8. The method of claim 7, further comprising
generating a core file corresponding to the executable file and the set of symbol files which includes appended source files when the program is to be debugged.

9. A computer-readable storage medium storing a computer program for appending source files for debugging the computer program, the computer program comprising executable instructions that cause a computer to:
receive object data and a plurality of matching symbol data corresponding to the source files;
first append the received object data to object files and the plurality of matching symbol data to a set of symbol files;
second append the source files to the set of symbol files; and
merge the object files and the set of symbol files.

10. The computer-readable storage medium of claim 9, wherein the executable instructions that cause a computer to merge comprises executable instructions that cause a computer to
discard duplicates of the plurality of matching symbol data and the source files.

11. The computer-readable storage medium of claim 9, further comprising executable instructions that cause a computer to
translate the source files to produce object data and a set of matching symbol data.

12. The computer-readable storage medium of claim 9, wherein the object files and the set of symbol files constitute same files, such that the executable instructions that cause a computer to first append and second append comprise executable instructions that cause a computer to
insert the received object data, the received plurality of matching symbol data, and the source files into the same files.

13. The computer-readable storage medium of claim 9, further comprising executable instructions that cause a computer to
generate an executable files by merging the object files, the set of symbol files, and library files.

14. The computer-readable storage medium of claim 9, further comprising executable instructions that cause a computer to:
generate an executable file by merging the object files and library files; and
append the set of symbol files to the executable file.

15. The computer-readable storage medium of claim 14, further comprising executable instructions that cause a computer to
store the executable file along with the set of symbol files which includes appended source files.

16. The computer-readable storage medium of claim 15, further comprising executable instructions that cause a computer to
generate a core file corresponding to the executable file and the set of symbol files which includes appended source files when the program is to be debugged.

17. A system for appending source files for debugging a program, comprising:
means for receiving object data and a plurality of matching symbol data corresponding to the source files;
first means for appending the received object data to object files and the plurality of matching symbol data to a set of symbol files;
second means for appending the source files to the set of symbol files; and
a linker to merge the object files and the set of symbol files.

18. The system of claim 17, wherein the linker comprises
means for discarding duplicates of the plurality of matching symbol data and the source files.

19. The system of claim 17, further comprising
a compiler to translate the source files to produce object data and a set of matching symbol data.

20. The system of claim 17, wherein the linker comprises
means for generating an executable files by merging the object files, the set of symbol files, and library files.

21. The system of claim 17, further comprising:
means for generating an executable file by merging the object files and library files; and
means for appending the set of symbol files to the executable file.

22. The system of claim 21, further comprising
a storage unit to store the executable file along with the set of symbol files which includes appended source files.

23. The system of claim 22, further comprising
a debugger to generate a core file corresponding to the executable file and the set of symbol files which includes appended source files.
